(19) United States
(12) Patent Application Publication
(10) Pub. No.: US 2008/0133074 A1
(43) Pub. Date: Jun. 5, 2008

(54) AUTONOMOUS ROLLOUT CONTROL OF AIR VEHICLE

(76) Inventors: Michael J. Zyss, Hacienda Heights, CA (US); Ashwani K. Chaudhary, Cypress, CA (US); David G. Childers, Long Beach, CA (US); Viet H. Nguyen, Cerritos, CA (US); David Poladian, Carlsbad, CA (US); Hoi T. Tran, Tustin, CA (US); Vincent L. Wong, Irvine, CA (US)

Correspondence Address: KLEIN, O'NEILL & SINGH, LLP, 43 CORPORATE PARK, SUITE 204, IRVINE, CA, 92606, US

(21) Appl. No.: 11/566,087

(22) Filed: Dec. 1, 2006

(51) Int. Cl. G06F 19/00

(52) U.S. Cl. 701/16; 701/3; 244/175

(57) ABSTRACT

A real time reconfigurable, fully integrated, fault tolerant guidance and control system to act in a coordinated fashion to bring a re-entry air vehicle or a UAV to a stop, while keeping it within runway bounds after a high-speed landing.

This invention was made with Government support under contract number F30602-03-C-2005 awarded by the U.S. Air Force. The government has certain rights in this invention.

### BACKGROUND

1. Field of the Invention

The invention is related to controlling an air vehicle after landing and during rollout to wheel stop and more particularly for controlling an air vehicle for an autonomous air vehicle rollout.

2. Related Art

Autonomous re-entry and unmanned autonomous vehicles need a high-speed, touchdown and rollout guidance and control system for fault tolerant ground operation and control. A re-entry vehicle or an Unpiloted Air Vehicle (UAV, must transition from the airborne phase to an autonomous landing on a standard paved runway.

During the autonomous landing phase, there are considerable uncertainties, including runway friction, tire effectiveness, landing gear damping and stiffness, braking effectiveness and asymmetries, aerodynamic uncertainties and the like, which a rollout guidance and control system must compensate for to maintain the vehicle within the confine of the runway. The guidance and control system has to provide stability and performance even when all the uncertainties are included in a worst-case alignment.

The rollout guidance and control system has to be fault-tolerant and assure safe rollout even when nosewheel steering or braking system components fail.

Accordingly, there is a need to provide an autonomous rollout guidance and control system that can be reconfigured in real time and provide for fault tolerant ground.

### SUMMARY

The present disclosure provides a solution for autonomously controlling an air vehicle during rollout. The invention may include a combination of guidance, navigation, and control subsystems and a plurality of effectors. The combination of subsystems uses logic to process data from the various effectors combined with navigational aids and guidance commands to handle failed sensors and effectors. The logic allows control of the various effectors in a coordinated manner to provide an autonomous air vehicle rollout. Embodiments of the disclosure will increase safety and performance margins and eliminate the need for expensive systems required to provide human intervention capability.

Unlike some systems currently available that require human intervention (either on-board or remotely) to keep the vehicle within runway limits, the present disclosure uses an autonomous reconfigurable fault tolerant guidance, navigation, and control system to control rollout. For example, the system of the present disclosure uses multiple effectors, such as the nosewheel, rudder, aileron, speed-brake, flap, left and right wheel brakes to keep a re-entry air vehicle or a UAV within runway bounds after a high-speed landing. Since all coefficients can be modified and filters re-initialized autonomously in real time compensation is possible for a given failure scenario.

This brief summary has been provided so that the nature of the invention may be understood quickly. A more complete understanding of the disclosure may be obtained by reference to the following detailed description of embodiments thereof in connection with the attached drawings

### BRIEF DESCRIPTION OF THE DRAWINGS

The foregoing features and other features of the present disclosure will now be described with reference to the drawings. In the drawings, the same components have the same reference numerals. The illustrated embodiment is intended to illustrate, but not to limit the invention. The drawings include the following Figures:

FIG. 1 is a simplified illustration of a representative air vehicle showing a general configuration for a high-speed rollout control of the air vehicle in accordance with an embodiment;

FIG. 2A is an architectural block diagram of a Rollout Control System (ROS) in accordance with an embodiment;

FIG. 2B is a flow diagram showing major functional/processing blocks of the RCS of FIG. MA, in accordance with an embodiment; and

FIGS. 3A, 3B and 3C graphically illustrate the simulated performance of rollout control system with a brake rotor failure during braking, in accordance with an embodiment.

### DETAILED DESCRIPTION

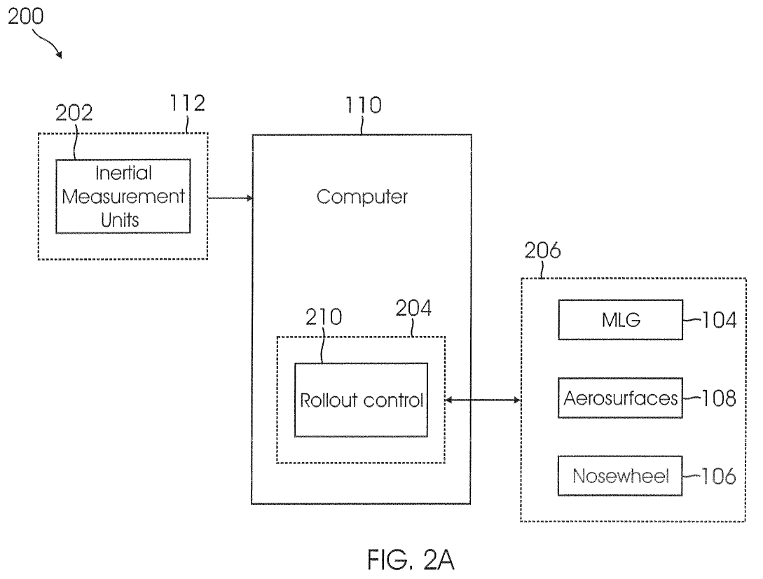

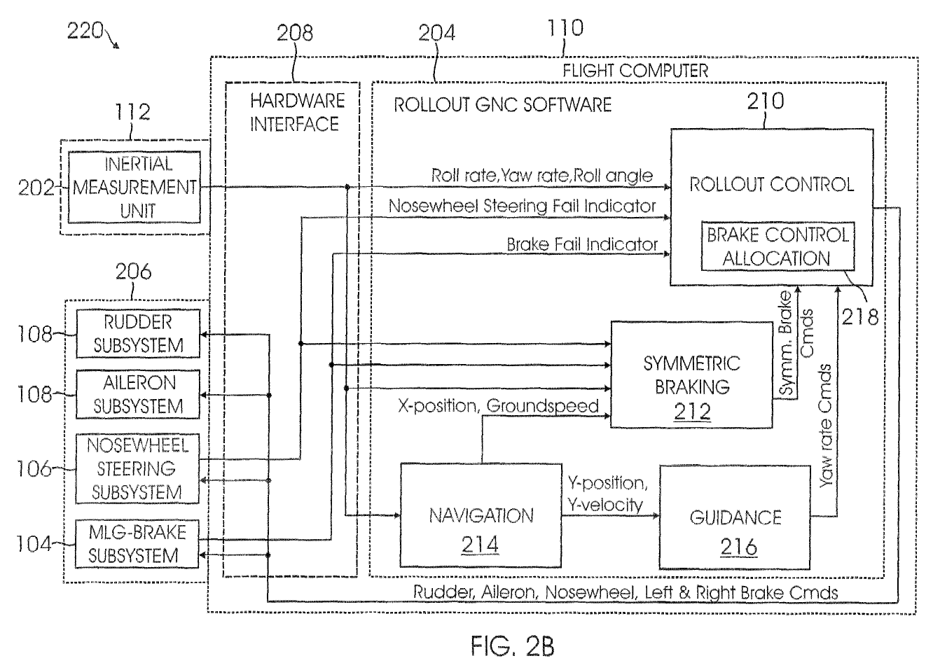

In one embodiment, air vehicle 100 includes a conventional landing system, including main landing gear (MLG) 104, nose landing gear 106 and aero surfaces 108, such as ailerons, rudders, and the like. The MLG 104 and nose landing gear 106 include gears, brakes, wheels and associated hardware as is well known in the art. In one embodiment, MLG 104 includes a left wheel and a right wheel with brakes, but may include any number or combination of wheels used for landing. Nose landing gear 106 includes nose wheel 114 with steering capability. Collectively, MLG 104, nose landing gear 106, and aero surfaces 108 are components of control effectors 206 (FIG. 2A).

Generally, air vehicle 100 also includes a processing means 110, including a computer or equivalent processor and a sensing system 112 (described below). Processing means 110 may be capable of responding to operational signals or electrical pulses from various sensors. In one embodiment, processing means 110 includes a Flight Management Computer IFMC) 110 or the equivalent, the functions of which are well known in the art.

FIG. 2A is an architectural block diagram of RCS 200 in accordance with an embodiment of the present disclosure. The RCS includes sensing system 112, rollout Guidance Navigation Control (GNC) 204, and control effectors 206, operationally controlled by processing means 110.

Sensing system 112 includes navigation/control sensing unit 202, which includes, in one embodiment, an Inertial Measurement Unit (IMU).

In one embodiment rollout GNC 204 may include rollout controller 210 and is operationally controlled by processing means 110.

In operation, landing air vehicle 100 has to stay close to the runway centerline and stop within the runway length, and width, while subject to the vehicle performance limitations. In addition, air vehicle 100 has to perform tracking and stopping tasks in the presence of head, tail, and crosswinds with nominal and failed subsystems In one embodiment, processing means 110 uses information provided by IMU 202 to monitor the distance between the position of air vehicle 100 and a side edge of a landing runway and an end of the length of the landing runway. Processing means 110 issues commands such that air vehicle 100 may be made to track the centerline of the landing runway.

In operation, once air vehicle 100 is on the ground, Rollout GNC 204 uses IMU 202 to compute the length of remaining runway and distance from runway edge. IMU 202 also supplies the position of air vehicle relative to the center of the runway. Data from calculations performed by Rollout GNC 204 using processing means 110 are used to automatically adjust the speed and downrange and cross-range demands of air vehicle 100 to safely control air vehicle 100.

For example, if data by IMU 202 indicate that air vehicle 100 is off of the centerline, Rollout GNC software 204 calculates corrective commands to rollout controller 210 to adjust aero surfaces 108, nose wheel 106, and left and right brakes 104 to steer air vehicle 100 back to the correct position.

In another example, if data by IMU 202 indicate that air vehicle 100 is approaching the end the runway, Rollout GNC 204 calculates a deceleration profile to issue commands to rollout controller 210 to adjust the braking levels of MLG 104 to brake air vehicle 100 to stop before the end of the runway is reached.

Rollout GNC 204 uses control effectors 206 of air vehicle 100 in an integrated fashion to avoid adverse effects that may be realized if control effectors 206 were not used in an integrated fashion. For example, the rudder controls yaw, but produces significant adverse roll. The symmetric brakes produce drag to slow air vehicle 100, but could produce significant asymmetric torques, which result in severe yawing. Nosewheel 106 provides yawing, but with its small deflections, it could remain within the hardware non-linearities, which produce limit cycles. A coordinated scheme as described in this invention allows for maximum effectiveness realized from each control effector 206, while not countering the effect or the effort realized of each other effector.

FIG. 2B is a block diagram 220 showing major functional/processing blocks and details of RCS 200 in accordance with an embodiment of the present disclosure.

Having already described the overall operation of RCS 200, the remaining description is concentrated on rollout GNC 204.

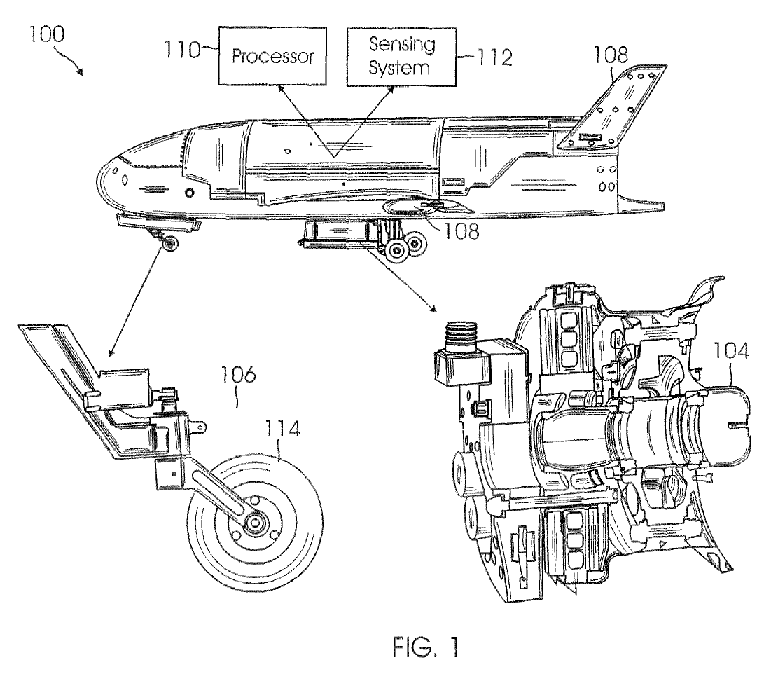

Referring now to FIGS. 1, 2A and 2B, processing means 110 hosts rollout GNC 204. Rollout GNC 204 communicates via hardware interface 208 with control effectors 206.

Rollout GNC 204 includes rollout control 210, symmetric braking control 212, navigation 214, and guidance 216.

Inputs to rollout control 210 may include the vehicle's roll angular rate, roll angle, and yaw angular rate as sensed by onboard IMU 202. Another set of inputs may include failure indicators, such as a nosewheel steering fall indicator and a brake fail indicator, notifying GNC 204 of failures in the corresponding systems.

Yet another input command is yaw rate command as computed by guidance 216 to track runway centerline as a function of the vehicle's lateral position and side velocity.

Still another input command is the symmetric braking command, which is used to bring vehicle 100 to a stop.

In one embodiment, the sensed inputs described above are filtered through standard 1st, 2nd, and/or notch filters to remove sensor noise, vehicle structural vibration and gear noise. The sensed inputs are combined with the yaw rate command via typical PID controllers, with PID gains scaled as a function of dynamic pressure (or airspeed or groundspeed), and IC distributed as commands to the various control effectors 206 (aero surfaces 108, nosewheel steering 106, and differential braking 104). The PID controller gains are re-scaled upon notification of nosewheel steering failure or brake failure via the failure indicators. The commands to the control effectors are limited to the specific effectors' deflection limit and rate limit

The differential braking command is combined with the symmetric braking command via the brake control allocation module 218 to form a Left and Right brake commands going to the brake actuators.

Symmetric braking module 212 includes a symmetrical brake logic (not shown) which ensures that the predetermined brake command is sufficient to stop the vehicle within runway bounds by continually calculating the distance between the vehicle's present position and the end of the runway. If an unpredicted high-energy state touchdown or rollout occurs and the pre-set nominal brake command profile is not sufficient to stop the vehicle by the end of the runway then the logic adjusts the command level such that the vehicle stops within runway limitations.

Brake control allocation logic block 218 receives command inputs from symmetric braking 212 and rollout control 210, which includes differential brake control algorithms. Brake control allocation logic block 218 then integrates, commands and allocates these commands to the individual brake assemblies. In one embodiment, the differential brake command is distributed at an optimal 50/50 ratio. If, however, there is insufficient symmetrical brake command present to cover a 50% differential subtraction then the remainder is added to the opposite side. For example, if no symmetrical brake command is present then all the differential command is added to one brake assembly since no differential command can be subtracted from the opposite side. The logic prioritizes commands based on the severity of the rollout scenario. For example, if the vehicle is close to the runway's end threshold then priority is given to the symmetrical brake commands to stop the vehicle safely on the runway. However, at high-speeds priority is given to differential commands to keep the vehicle on track with the runway centerline.

Embodiments of the logic provide a system that reconfigures priorities if a fail should occur with the control effectors. For example, if the system detects a nosewheel steering failure the control allocator reconfigures and gives priority to differential braking to makeup for the loss in lateral control authority.

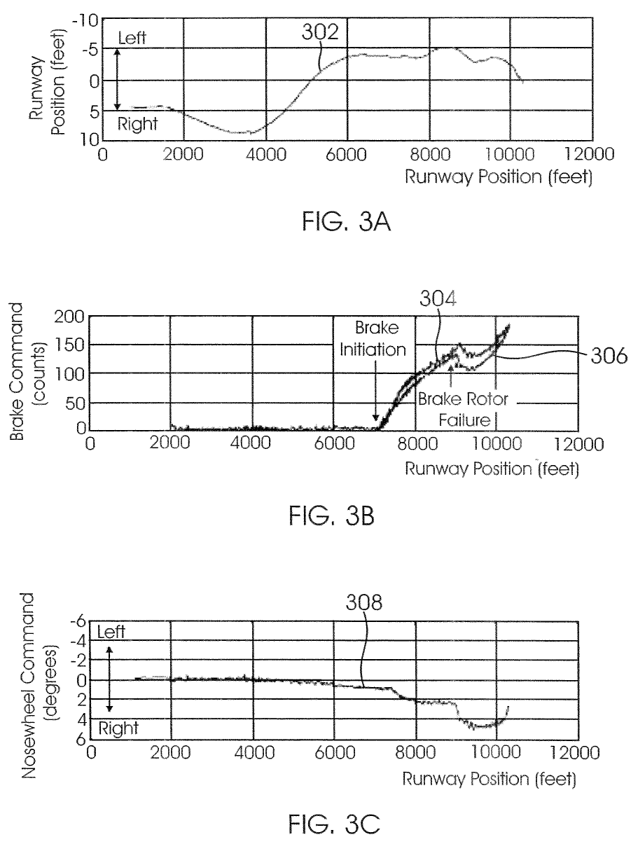

FIGS. 3A, 3B and 3C illustrate of the simulated performance of rollout control system 200 of unmanned air vehicle 100, which suffered a brake rotor failure following brake initiation. The invention safely reconfigured the rollout control system 200 and brought air vehicle 100 to a safe stop on the runway and within inches of the runway centerline.

Graph 302 shows air vehicle's 100 displacement relative to a centerline along a runway. Graphs 304 and 306 show air vehicle's 100 right and left brake commands respectively, along the runway. Graph 308 shows nosewheel command along the runway. Due to uneven brake performance, more right wheel and right nosewheel command are required to counter the asymmetry.

Brakes are initialized at 7000 feet. A right brake rotor fails at the 9000 feet point of the runway (1 of 3 rotors fails). Once the failure is detected, a corresponding left brake rotor is disabled to maintain brake symmetry, brake gain and nosewheel steering gain are adjusted in real time to this new configuration.

Air vehicle 100 comes to a stop at 10200 feet point of the runway and only inches from the centerline.

Although the present disclosure has been described with reference to specific embodiments, these embodiments are illustrative only and are not limiting. Many other applications and embodiments of the present disclosure will be apparent in light of this disclosure and the following claims.

What is claimed is:

1. A reconfigurable system for controlling effectors of an air vehicle for an autonomous rollout, the system comprising:
a plurality of effectors arranged on an air vehicle;
a guidance and navigation system for calculating the distance between a position of the air vehicle and a position on a landing runway and for issuing a flight control command in response to the distance calculations; and
a processing means for receiving a flight control command from the guidance and navigation system and coordinating control of the plurality of effectors in response to the flight control command to cause the air vehicle to track along a predetermined position on the landing runway.

2. The system of claim 1, wherein the distance between the position of the air vehicle and the position on the landing runway comprises a distance between the air vehicle and an edge of the width of the landing runway.

3. The system of claim 1, wherein the distance between the position of the air vehicle and the position on the landing runway comprises a distance between the position of the air vehicle and an end of the length of the landing runway.

4. The system of claim 1, wherein the distance between the position of the air vehicle and the position on the landing runway comprises a plurality of distances including a distance between the air vehicle and an edge of the width of the landing runway and a distance between the position of the air vehicle and an end of the length of the landing runway.

5. The system of claim 1, wherein the predetermined location on the landing runway comprises the centerline of the landing runway.

6. The system of claim 1, wherein said processing means further comprises a redundancy management scheme for reconfiguring and coordinating control between said plurality of effectors when at least one effector has failed.

7. The system of claim 1, wherein said plurality of effectors comprises a nosewheel, ailerons, flaps, a rudder, a speed-brake, and brakes.

8. A method for controlling effectors of an air vehicle for an autonomous rollout, the method comprising:
providing an air vehicle including a plurality of effectors arranged on the air vehicle;
calculating the distance between a position of the air vehicle and a first location on a landing runway;
generating a flight control command in response to the distance calculation; and
coordinating control of the plurality of effectors in response to the flight control command to cause the air vehicle to track along a predetermined location on the landing runway.

9. The method of claim 8, further comprising reconfiguring and coordinating control between said plurality of effectors using a redundancy management scheme when at least one effector has failed.

10. The method of claim 8, wherein said plurality of effectors comprise a nosewheel, ailerons, flaps, a rudder, a speed-brake, and brakes.

11. The method of claim 8, wherein calculating the distance between the position of the air vehicle and the first location on the landing runway comprises calculating the distance between a position of the air vehicle and an edge of the width of a landing runway.

12. The method of claim 8, wherein calculating the distance between the position of the air vehicle and the first location on the landing runway comprises calculating the distance between the position of the air vehicle and an end of the length of the landing runway.

13. The method of claim 8, wherein calculating the distance between the position of the air vehicle and the first location on the landing runway comprises calculating the distance between a position of the air vehicle and an edge of the width of a landing runway and the distance between the position of the air vehicle and an end of the length of the landing runway.

14. The method of claim 8, wherein the predetermined location on the landing runway comprises the centerline of the landing runway.
